(19) United States
(12) Patent Application Publication
(10) Pub. No.: US 2015/0046646 A1
(43) Pub. Date: Feb. 12, 2015

(54) Virtual Network Disk Architectures and Related Systems

(71) Applicant: Ihab H. Elzind, San Jose, CA (US)

(72) Inventor: Ihab H. Elzind, San Jose, CA (US)

(21) Appl. No.: 13/960,813

(22) Filed: Aug. 7, 2013

(51) Int. Cl. G06F 3/06

(52) U.S. Cl. CPC G06F 3/0689; G06F 3/0619; G06F 3/065
USPC 711/114

(57) ABSTRACT

In accordance with one embodiment a disk drive device comprising: a disk drive; at least one Ethernet port; at least one powerful low power processor capable of running storage protocols; and one or more Ethernet circuits, wherein one or more of the Ethernet ports provide a power transmission medium which powers the disk drive.

### CROSS REFERENCE TO RELATED APPLICATION

This application claims the benefit of the provisional application Ser. No. 61/679,799, filed 2012 Aug. 6 by the present inventor EFS ID: 13420878.

### BACKGROUND

### Prior Art

The following is prior art that presently appears relevant:

U.S. Patent

| Pat. No. | Kind code | Issue Date | Patentee |
|---|---|---|---|
| 7,792,923 | B2 | Sep. 7 2010 | Han-Gyoo Kim |

U.S. Patent Application Publications

| Publication Nr. | Kind code | Publ. Date | Applicant |
|---|---|---|---|
| 20060010287 | A1 | Jan. 12 2006 | Han-Gyoo Kim |

### BACK GROUND OF THE INVENTION

1. Technical Field

The computer data storage technology revolves around the disk drive. While the dominant disk drives technology remains to be the mechanical disk drive technology. Advances in flash memory are making the solid-state disk drive known as SSD the future technology to replace the mechanical disk drive. Disk drives have no intelligence. They rely on SAN or NAS controllers or directly attached to server that controls them. Once it's controlled it's presented as a data storage device in a form of NAS “network attached file system storage” or a SAN “storage array network” or a directly attached local disk drive.

2. Related Art

Disk drives are the backbone of today's storage systems, most storage systems consist of a rack populated by disk drives. The rack will either have a controller or will be attached to a separate controller.

The controller performs numerous functions such as reading and writing data to the disk drives, exporting files systems from the disk drives in a NAS “network attached storage” configuration, allowing access to the disk drive as a block storage device in a SAN configuration.

The controller usually run software that supports protocols and file systems such as ISCSI, NFS, CIFS to allow users access to storage devices over the networks. The controller also provides additional functions to increase reliability of the disk drive such as:
Striping of data across the disk drives in the rack, avoids having all the data on one disk drive.
Mirroring of the data on different disk drives where the mirror disk is to recover data from a disk failure.

These functions are called RAID levels stands for redundant array of independent disks. Direct attached storage disk drive attached to a server or a computer is another way of using a server or computer as the controller to make the disk drive appear as a storage medium. Prior art cited in this application above shows another way of making networked disks appear as local disk drives by extending the control function over Ethernet network and issuing local commands to the disk drive over Ethernet links. This prior art of SAN and NAS controllers are very high performance but very expensive. The other prior art of direct attached, whether directly connected or over Ethernet is limited, not flexible as it does not have higher level SAN/NAS protocols or routing protocols. It also leaves all the work for the server controlling the direct attached disks. The invention described herein takes advantage of powerful processors developed for tablets and powerful smartphones and embeds them as controllers inside disk drives to serve SAN and NAS protocol's right out the disk drive.

### SUMMARY

In accordance with one embodiment a disk drive device comprising of:

a disk drive, a minimum of one Ethernet port, powerful low power processor capable of running storage protocols and power over Ethernet circuits to derive its power from the power over Ethernet standard.

### Advantages

Accordingly several advantages in a number of aspects are as follows: having a dedicated powerful processor in the disk drive serving only one disk drive boosts the performance to that of high end SANS and NAS controllers while serving NAS and SAN protocols out of the disk drive.

Given that the processor is low power intended for tablet and smart phones allows the use of power over Ethernet standard which is higher efficiency and result in an overall low power consumption storage solution.

Given that the processors are meant for low cost tablet and smartphones market we end up with a low cost disk drive storage solution.

In conclusion, by changing the disk drive architecture to include a powerful processor inside it, we get high performance ability to serve SAN and NAS protocols at lower cost and lower power.

### LIST OF FIGURES

FIG. 1 Shows prior art technology and the present invention

FIG. 2 Shows the present invention composition

FIG. 3 Shows the architecture of the present invention usage

FIG. 4 Shows the building blocks of the controller SOC

FIG. 5 Cludio cloud disk IO

FIG. 6 Cloud application

FIG. 7 Host bus adapter

FIG. 8 Host bus adapter internals

FIG. 9 Broadcast or multicast packet Data Packet

FIG. 10 Ethernet disk drive

FIG. 11 Ethernet disk drive with bracket for rack mounting

FIG. 12 Ethernet disk drive with power management module

FIG. 13 Multicore processor controller

FIG. 14 Mechanical hole pattern

Omit FIG. 15

### DETAILED DESCRIPTION

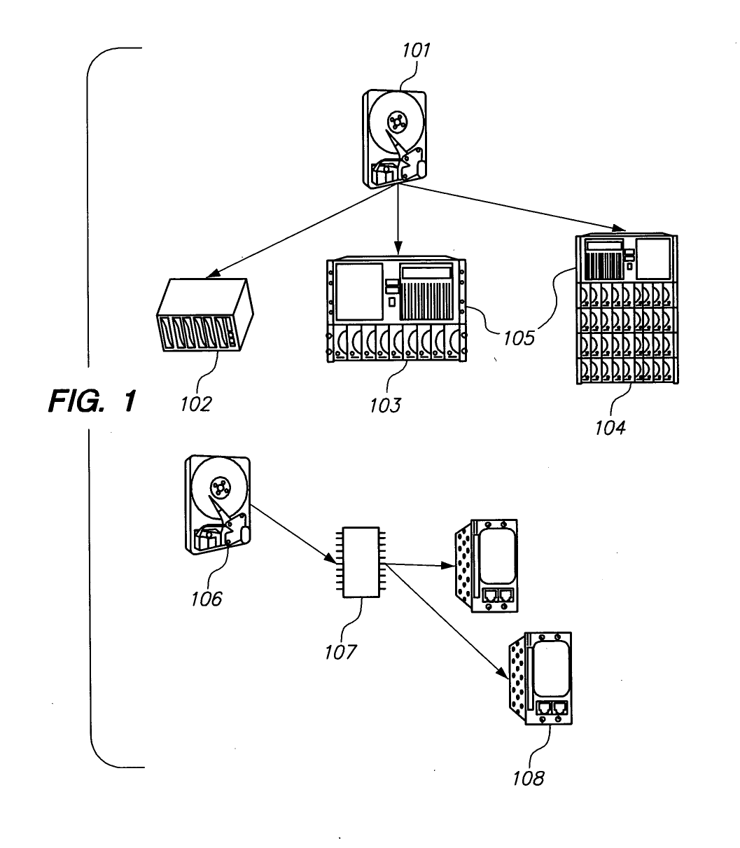

FIG. 1 shows existing technology composition of storage devices and usage. In 101 the basic building block is the disk drive SSD or mechanical. In 102, we have a rack of disk that will normally be connected to a controller such as a RAID controller then directly connect to a server, 103, 104 shows a SAN or NAS storage system where the controller 105 is built in. The SAN/NAS storage systems will also include the power supply for the disks and the controller, cooling fans which makes it a very expensive system, in today's IT infrastructure the storage systems are the most expensive.

The invention described here describes a way of a new architecture of SAN/NAS that decrease the cost significantly.

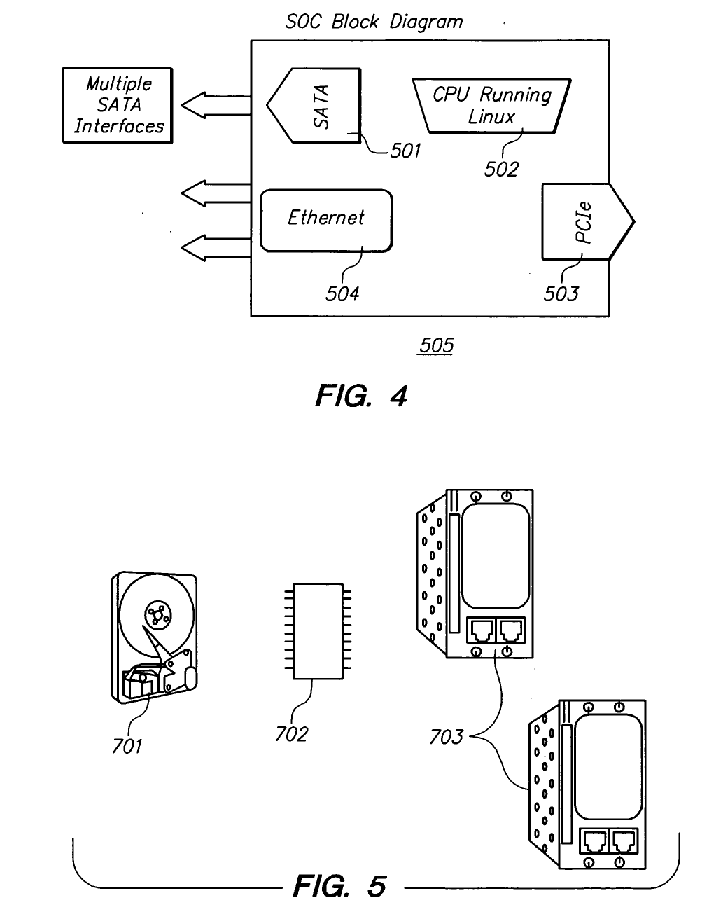

The proposed invention combines the disk drive shown in 106 with a built in controller 107 silicon system on a chip with a block diagram shown in FIG. 4.

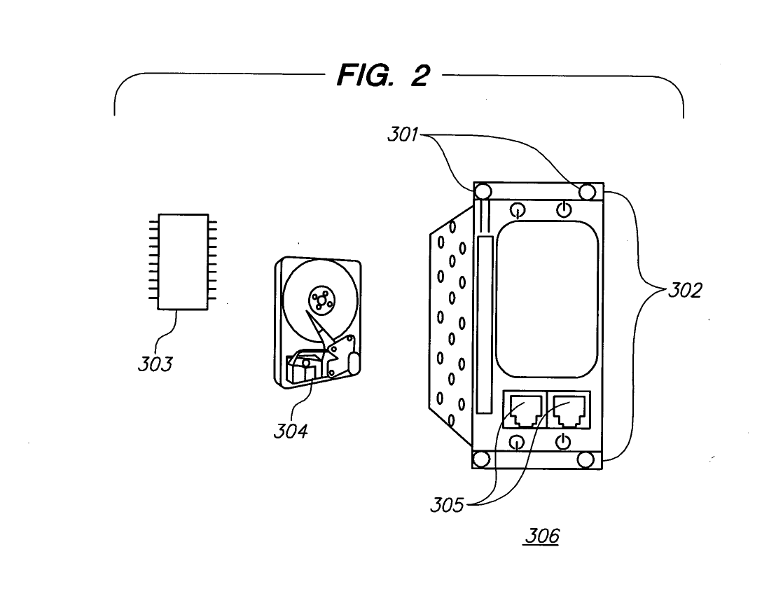

By doing so the disk drive by itself becomes a SAN/NAS shown in FIG. 2 306. The SOC 505 in FIG. 4 will perform the function of the NAS/SAN controller and support the RAID, IPSCSI, FCOIP, file system serving such as NFS, CIFS and so on. The combined disk and controller will make up the new disk SAN/NAS system shown in FIG. 1 108.

The new disk SAN/NAS system invention is shown in FIG. 2 306. The invention will have a minimum of two Ethernet ports shown in FIG. 2 305,

It will also have a controller 505 and a disk drive mechanical or SSD “solid state disk”.

The controller will provide ISCSI target functionality as well as NAS NFS CIFS functions and RAID. When the end users require more storage capacity additional disk will be added on the network on the network switch.

FIG. 2 shows 2 network interfaces 305, one of them is the primary Ethernet port that serves the users the 2^{nd} will be dedicated to the redundancy functions such as RAID, replication, management and backup.

The present invention will also use the Ethernet ports in 305 to power itself up from the network switch using the power over Ethernet standard and power over Ethernet capable network equipment.

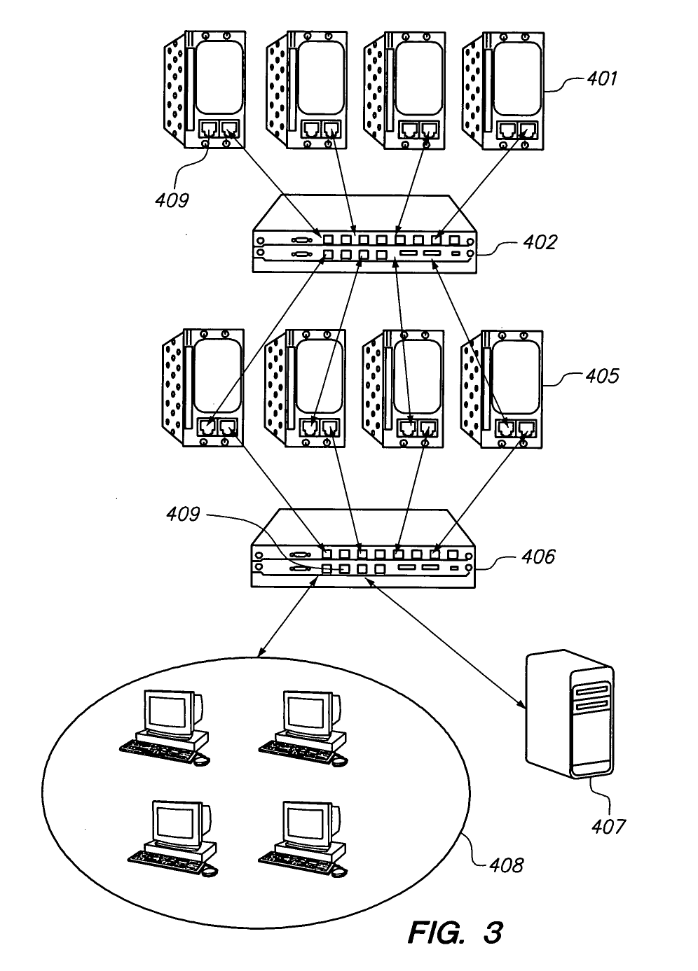

FIG. 3 shows the proposed connection and usage topology. FIG. 3 406 is the main network switch where the users 407 and the servers 408 are connected with the present invention storage array 405. The present invention 405 array can be powered from the switch using POE “stands for power over Ethernet” or they could have their power adapters.

The network switch 402 is a standard network switch that could have POE “power over Ethernet” feature, It serves as the network switch that will carry all the RAID redundancy such as mirroring stripping and all other RAID levels available today in the market to alleviate the redundancy overhead on the user network switch shown in 406.

The secondary switch will serve also additional functions such as replication and backup to also further reduce the overhead on the user switch 406.

The present invention can also mirror itself on one to one basis or one to many bases.

The present invention can also stripe itself on one to one basis or stripe itself on one to many bases, which helps SSD, drives by increasing their endurance. FIG. 5 shows an extension of the present invention to cloud environment by embedding a virtual machine running under a hyper visor into the controller shown in 702. 703 shows the present invention integrated with a virtual machine miming on the controller 702 and showing up as an ISCSI target.

The advantage of using the virtual machine architecture is for the fact it allows the entire virtual machine to be moved. For example the disk present invention in 703 as a virtual machine can be moved/copied to another disk as the one shown in 703 that have bigger capacity. If a disk drive 701 is added to 703 the hypervisor can add it to the virtual machine to increase the capacity of 703. The present invention described and shown in 703 will be referenced from now as Cludio, which stands for cloud disk IO.

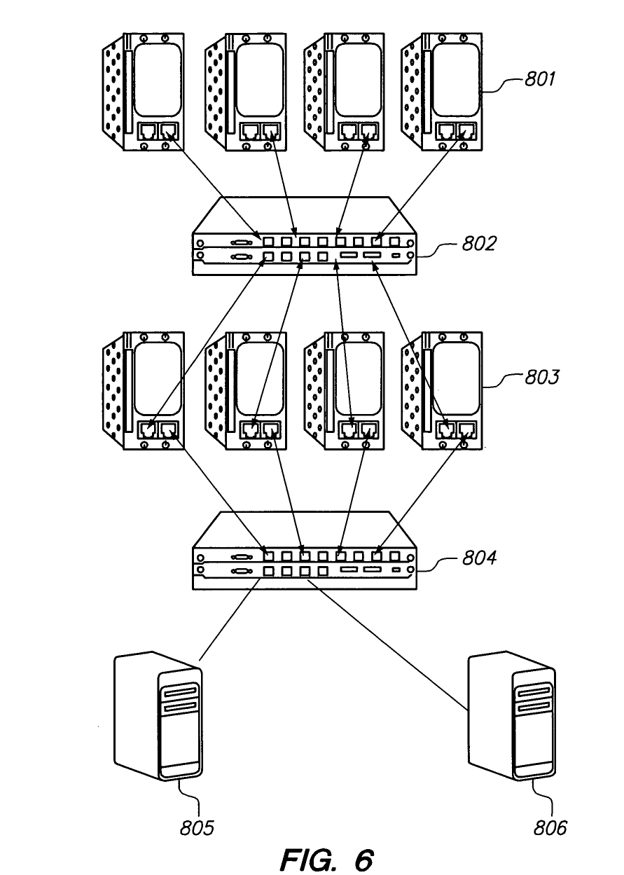

FIG. 6 shows that a group of Cludios shown in 803 on a network switch 804 each is an ISCSI target virtual machine, the server 806 whether virtual or physical server can mount all the Cludios and make a combined bigger file system containing all the Cludios.

The advantage of 806 being virtual server under a hypervisor makes it movable copy-able and accessible to other virtual servers.

To further improve performance prior art of using host bus adapter “HBA” off load engines are commonly used. These off load engines improve performance by offloading the host CPU from having to deal with the overhead of the ISCSI protocol, they are also used as TOE “TCP off load engines” to offload the TCP/IP encapsulation as well.

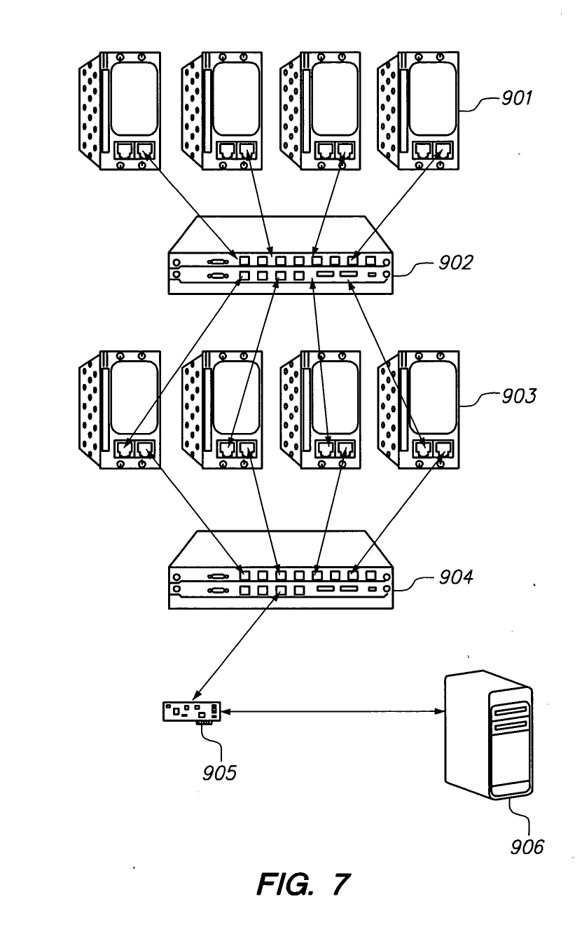

FIG. 7 shows an offload engine host bus adapter 905 that goes inside a server 906 which could be a physical server or a virtual server with hypervisor and multiple virtual servers running on it.

In that scenario shown in FIG. 7 the HBA acts as the off load engine also with advances in technology, it can run its own operating system or a hyper visor and multiple operating systems where its acts as the ISCSI initiator.

In that case with a full operating system in addition to the ISCSI initiator and TCP/IP offload it can perform the loading of all the Cludios into a larger LUN, file system or even Raid configurations.

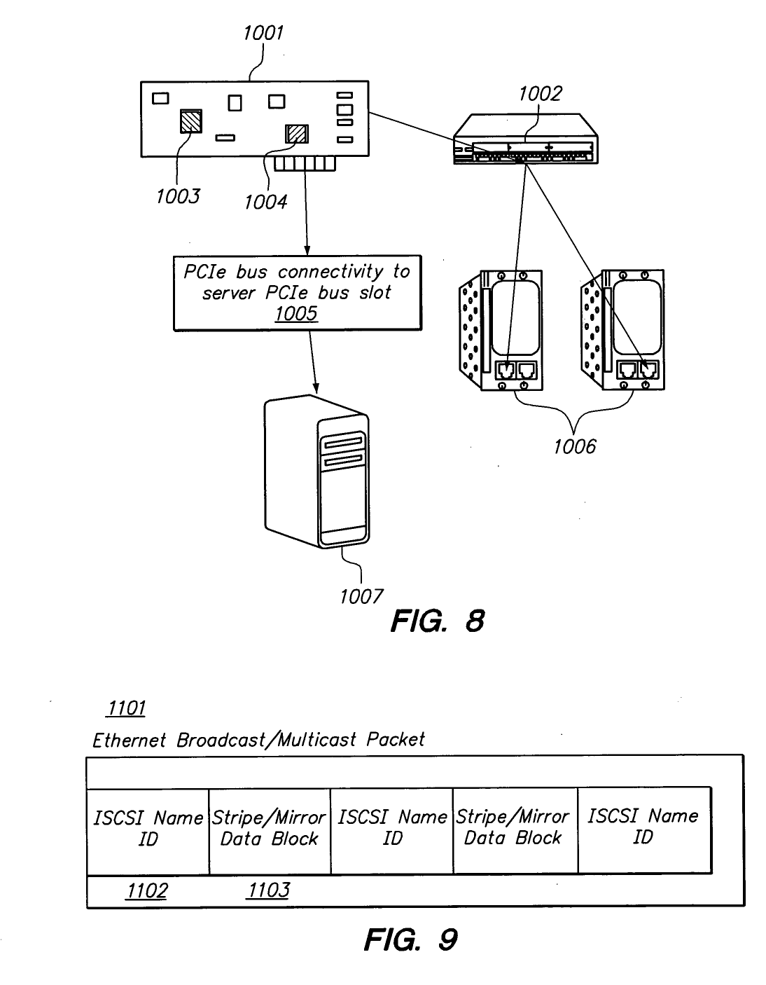

FIG. 8 shows the composition of the HBA card 1001 we will use with the present invention. It has a CPU 1003 that runs either a standalone OS or a Hyper visor that runs a virtual machine. It has a host bus interface such as PCIe or PCI 1005 that allows it to connect internally to the hosting server 1007.

In order to communicate to the host server 1007 a need for a bridge chip 1004 to facilitate communications between the CPU 1003 and the host 1007.

The CPU 1003 will connect to the Cludios 1006 using Ethernet via the Ethernet switch 1002 and aggregate them as ISCSI targets while the CPU 1003 becomes the ISCSI initiator. Using the bridge chip 1004 the CPU 1003 will appear to the host 1007 as storage device to the OS residing on the host 1007 whether it is a stand alone OS or a hyper visor with multiple OS's on it.

### Tuning Algorithm:

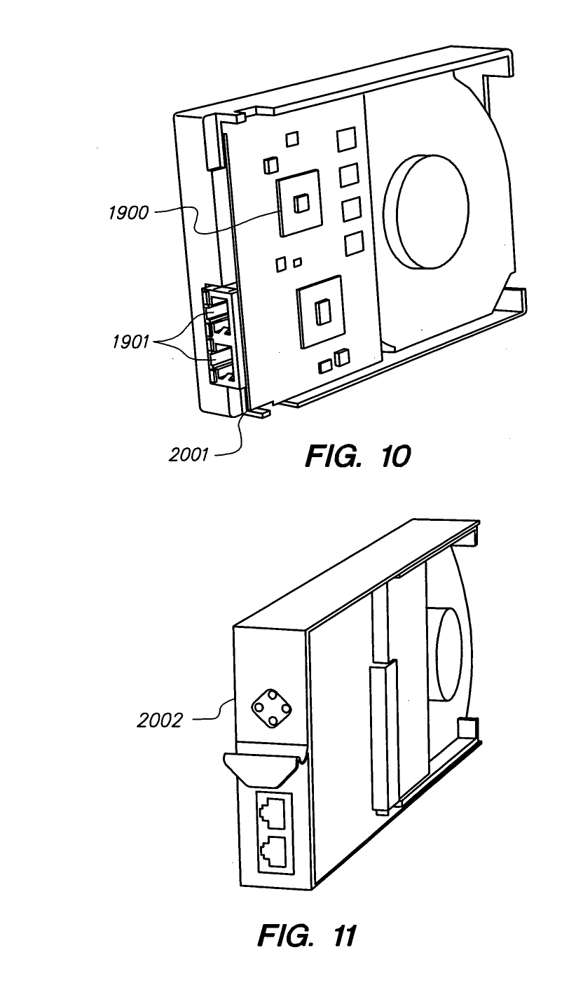

The CPU 1003 can run a tuning algorithm by creating different storage sector sizes x time 512 byte and so on for a total length of n time 128 k bytes, then the CPU 1003 will run a regressive loop of writing these sector of n times in this order:
Start with x time 512 byte sectors where x ranges from 1 to 8000 or more as needed and for N times 128 Kbytes where N ranges from 1 to 10000 or more as needed.
So for every x(512) run n times 128 k bytes to be stored on a disk drive shown in FIG. 9 1006.
Calculate the transfer speed and the latency, the disk performance will vary because of disk speed, sector sizes buffers and so on so the idea is to find the limits of these disk drives to determine how to transfer data to them in real life situation below these boundaries for the first disk drive then continue the transfer to the next disk drive in the group 1006. This basically avoids the limits of the disk drives by chunking up the data into optimal chunks that maximize the performance by avoiding bottlenecks such as buffer sizes, switching from a track to track and disk latencies.

### Power Management:

The disk drives often require a high startup current and then the current requirements are reduced as the disk reaches operational state as shown in the table below.

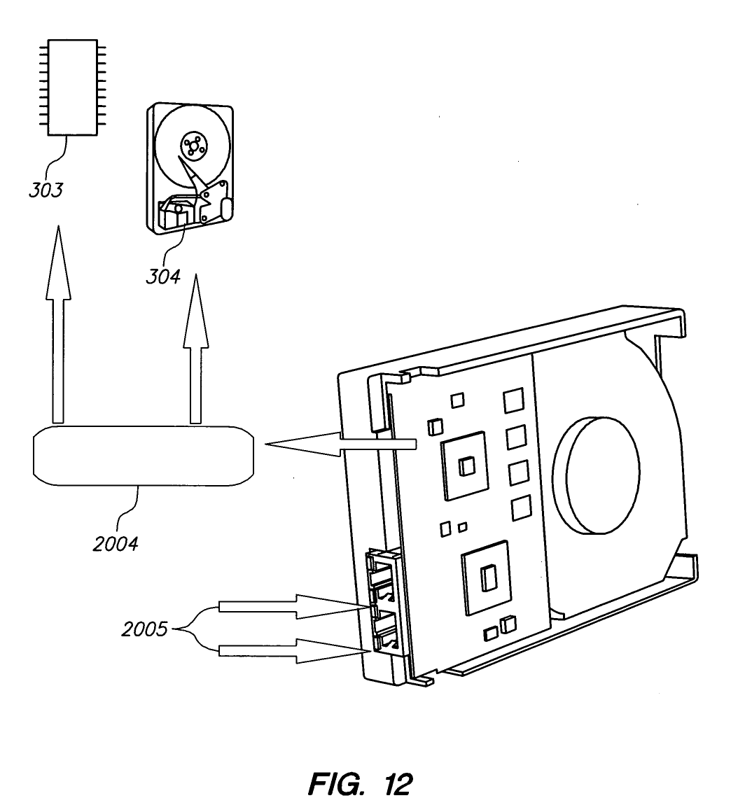

This can cause a problem with a power over Ethernet powered device such as the device described in this invention shown in FIG. 2 306. The reason for that is the power over Ethernet has a limited amount of current to resolve this issue a power management module is added to the device as shown in FIG. 12 2004.

| | |
|---|---|
| Power | +5 VDC (+/−5%) |
| Requirement | +12 VDC (+10%/−8%) |
| Startup current (A, max) | 1.2 (+5 V), 2.0 (+12 V) |

This power management unit servers multiple purposes, one purpose is to keep the controller 303 in FIG. 2 powered down until the startup current of the disk drive subsides and becomes low enough to safely power up the controller without tripping or blowing a fuse on the power over Ethernet port.

The other purpose is to use the two Ethernet ports to combine their power over Ethernet to feed different loads with power, as shown in the diagram below the power management module employs a switching matrix that routes the loads to the different loads to the two power sources coming from the Ethernet ports. The switch matrix uses a make before break mechanism to insure no glitches to the power during switching.

The power management unit will work with the controller 303 in FIG. 2 to implement a full wake over LAN protocol. The advantage of this feature allows the drives shown in FIG. 3 405 to be able to have additional spares like the ones shown in 401 FIG. 3 where they could be powered down then when needed in case of a failure they could be powered up and brought on online using wake on LAN protocol.

### Multicore Controller:

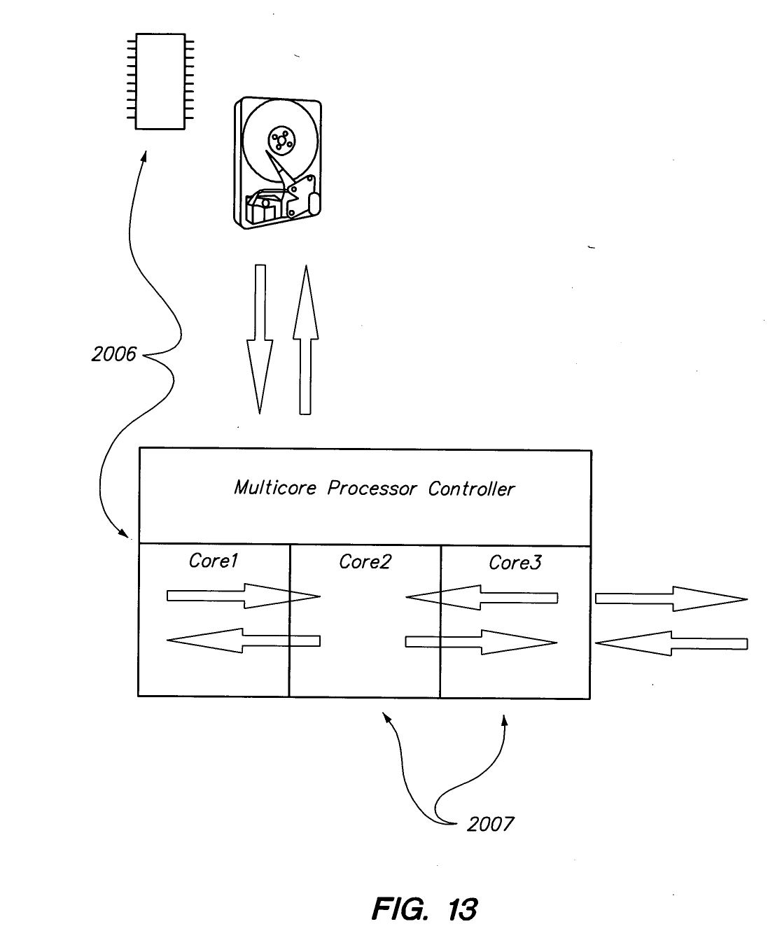

The controller in FIG. 2 303 has a multicore CPU in it and can run a hypervisor. The multiple cores shown in FIG. 13 2006 have a bidirectional communications channel between them to allow the cores to talk to each other and exchange data with or without the use of DMA. The bidirectional communication channel can also be used to communicate with other controllers in other drives or outside devices. The ability to have bidirectional communication to outside devices is particularly important in low latency trading where the need to access the date with minimum overhead is quite important. This communication channel will resemble a SERDES interface commonly found in high speed interfaces. This interface will also have the ability to do a pass through driver bypassing the hypervisor if needed.

The cores will have some of the following features below:
Support for KVM, Xen are mandatory VMware optional.
Linux OS support.
JO inclusive virtualization support.
Support for ECC and non-ECC memory.
Up to 1.5 GHz or more clock speed with a power budget not to exceed 9 watts Max is desirable.
Memory support up to 128 Giga-bytes.

The peripherals of the cores will be similar to features below:

1. Dual 10 Gig Ethernet at minimum three is desirable per core if possible.

2. Dual 1 Gig Ethernet per core at minimum.

3. SATA 3.0 support dual interface.

4. 3 PCIe gen2 or better that can handle 2 PCIe X 4 and 1 PCIe X1, 1 PCIE x 8 and 1 PCIe X1, or 9 PCIE X 1.

5. Full DMA support from peripherals from and to peripheral to peripheral, memory to peripheral and vice versa per core.

6. Serial rapid IO or equivalent.

7. Full 10 virtualization support including PASS through.

8. Ability to turn off or standby unused cores.

9. Security crypto engine.

10. Raid accelerator 5/6.

11. Pattern match engine.

12. SATA storage related features described separately.

13.2 DUARTS.

14. 1 I2C.

15. 1 SPI.

16. GPIOs.

The controller could also boot from a separate flash storage or from the disk drive shown in FIG. 2 304 whether mechanical or SSD.

### Form Factor:

The current invention shown in FIG. 11 2002 where the it needs to fit in a rack like the one shown below, will utilize a bracket and a heat sink 2003 shown in FIG. 11 in such a way that the heat sink will not protrude into the next slot of another disk drive meaning that the heat sink will not exceed the depth of a standard 3.5 disk drive.

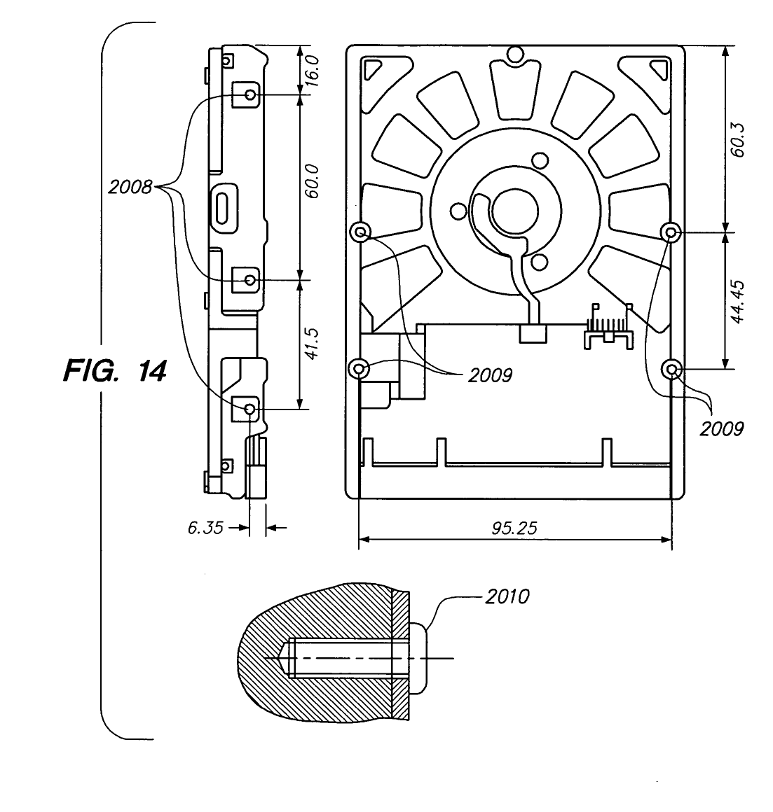

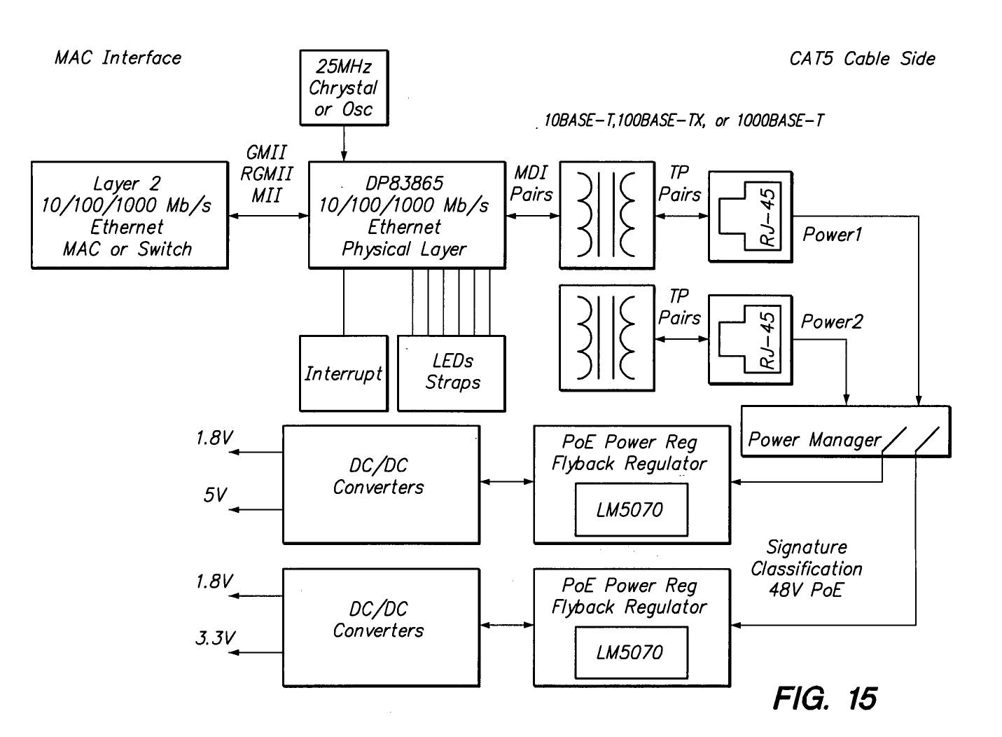

The bracket and the assembly shown in FIG. 112002 will have the hole patterns on the 2 sides and the top those of which match the dimensions of a 3.5 inch disk drive shown in FIG. 14.

1. The device of FIG. 2 306 where it consists of a disk drive mechanical or solid state “SSD” a controller IC system on a chip or controller board a minimum of one Ethernet port or more 305.

2. The device of claim 1 where it has a mounting flange or mechanism to mount it into a computer rack or shelf.

3. The device of claim 1 where it has a minimum of one or more Ethernet ports.

4. The device of claim 1 where it gets its power from a power connector on it or through the Ethernet port using power over Ethernet.

5. The device of claim 1 where it uses one Ethernet port to serve storage protocols such as ISCSI, FCOE, FCOIP.

6. The device of claim 1 where it uses an Ethernet port to serves the function of NAS serving NAS file systems such as NFS, CIFS and other formats of files systems.

7. The device of claim 1 where the other Ethernet ports are used to serve RAID functions to other devices such as the device of claim 1.

8. The device of claim 1 where the other Ethernet ports are used to serve backup and replication functions to other devices such as the device of claim 1 to reduce.

9. The device of claim 1 where the primary Ethernet ports serves the users of the storage where the other Ethernet port serves RAID, back up, management and replication to reduce this type of traffic from the primary port network serving the users.

10. The device of claim 1 where the controller run a hypervisor.

11. The device of claim 1 where the hypervisor runs a virtual machine that makes the disk drive appear as an ISCI target.

12. The device of claim 1 where the controller runs a non-virtualized operating system.

13. The device of claim 1 and claim 11 where the hypervisor allows the ISCSI target with the stored data on it to be copied or moved as a virtual machine entity.

14. The device of claim 1 where the non-virtualized operating system makes the disk drive looks like an ISCSI target.

15. The device of claim 1, claim 11 and claim 12 where the operating systems can serve a file system such as NFS, CIFS and PNFS.

16. The device of claim 1 where it can have more than one disk drive SSD or mechanical.

17. The device of claim 1 where it can have a SSD and a mechanical disk drive.

18. The device of claim with 2 drives where the SSD drive serves the function of a cache for a mechanical drive.

19. The device of claim 1 where it has a SSD drive and uses the second Ethernet port to apply RAID functions to other devices like the one in claim 1 with mechanical disk drive that are lower cost.

20. The device of claim 1 where multiple of such devices can be on two different network switches, one switch for primary access to the storage the other switch for RAID, backup, replication and management.

21. The device of claim 1 where multiple of such devices can be on one network switch, but with two multiple VLAN tags on the switch for primary access to the storage the other VLAN's for RAID, backup, replication and management.

22. The device of claim 1 where the second Ethernet port in 409 is connected back to the main switch 406 to serve as a fail over for one of the san array devices of claim 1 shown in 405.

23. The device of claim 1 and claim 21 when the fail over occurs the from one of the disks “the present invention” in 409 take the network identity of the failed disk from 405 and provide the storage on the network for the failed disk.

24. Multiple of the device of claim 1 that connects to an offload engine shown in FIG. 7 905, where the offload engine is a host bus adapter inside a server computer.

25. The off load engine of claim 23 where it can connect to multiple devices of claim 1 and consolidate them into a large storage.

26. The off load engine of claims 23 and 24 where it presents itself to the host server via a bus like PCIe as a consolidated storage.

27. The device of claim 1 shown in 405 where it can mirror itself to one or more devices in 405.

28. The device of claim 1 shown in 405 where it can stripe itself to multiple devices in 405.

29. The device of claim 1 in 405 where it can mirror or stripe itself or both using a broadcast or a multicast data packet such as Ethernet to eliminate having to send multiple packets to the mirroring and striping devices.

30. Claim 28 where the broadcast/multicast packets go over a VLAN.

31. The broadcast or multicast packet in FIG. 9 1101 where the node of claim 1 that accepts the stripping or mirroring data block identifies whether the block is for it or not, by examining the name field in the packet 1102 and determining that the block of data 1103 is for it or for another node.

32. The device of claim 1 as shown in FIG. 10 from factor as a fully integrated disk drive, including Ethernet ports 1901 computer controller unit 1900.

33. The device of claim 1 and claim 32 where the controller IC 1900 is a single or a multicore processor, with a complete TCP/IP network stack, running storage protocols such as ISCSI, NFS, object storage and HADOOP.

34. The device of claim 1 and claim 32 where is can be enclosed in a bracket shown in FIG. 11 2002 allowing it to be plugged in a rack mount enclosure.

35. The device of claim 1, claim 32 and claim 34 where it has a heat sink in FIG. 11 2003 on it without protruding into the next slot in the rack.

36. The device of claim 1, claim 32 and claim 4 where it has a power management unit shown in FIG. 12 2004.

37. The device of claim 1, claim 32, claim 36 and claim 4 where the power management unit in FIG. 12 2004 will serve the function of power control and sequencing, where it will power the disk drive mechanism shown in FIG. 12 304 first which requires an initial high current surge then stabilizes and its current goes down to steady state then power the processor and the various electronics shown in FIG. 12 303 to further eliminate the disk drive and the electronics powering up at the same time and running the power over Ethernet supplier out of current because of the initial surge from the disk drive.

38. The device of claim 1, claim 32, claim 36 and claim 4 where the power management unit can get power from both Ethernet ports in FIG. 12 2005.

39. The device of claim 1, claim 32, claim 36 and claim 4 where the power management unit can get power from both Ethernet ports in FIG. 12 2005, and manage the power from both Ethernet ports to deliver them to different sections of the device further eliminating the limitation of limited power available from a single power over Ethernet port.

40. The device of claim 1 and claim 32 where the controller shown in FIG. 5 702 and FIG. 13 2006 has a multicore processor, where the multicore processor individual cores shown in FIG. 13 2007 can have a communication channel between them to communicate with each other and with outside devices where they can change information.

41. The device of claim 1 and claim 32 where it uses the wake on LAN protocol where it can be a in a low power state with the disk drive is powered down or in a low power state and wake up and function using wake on LAN protocol.

42. The device of claim 1 and claim 32 where it has a fastening screws pattern and dimensions shown in FIGS. 14 2008 and 2009.

43. The host bus adapter and off load engine 1001 shown in FIG. 8 where the host bus adapter HBA determines the size of files to be stored and splits them in chunks to be sent and spreads them on a number of different drives shown I 1006 in such a way that the chunks sizes are optimized for the best performance and transfer rate, The chunk sizes are determined by running an initial setup test that determines the chunk sizes by testing the buffer sizes of the drives and the ISCSI target to insure best latency, transfer rate and overall performance.

44. The device of claim 1 and claim 32 where it has a boot flash disk to boot its own operating system from, and having a mechanical or a SSD disk drive for the ISCSI partition.

45. The power management module of claim 38 where it employs switches that can perform make before break function.
